(19) United States
(12) Patent Application Publication
(10) Pub. No.: US 2006/0052887 A1
(43) Pub. Date: Mar. 9, 2006

(54) Audio electronic watermarking device

(76) Inventors: Toshifumi Sakaguchi, Suginami-ku (JP); Masahide Hayama, Yokohama-shi (JP); Yukihisa Inoue, Yasu-gun (JP)

Correspondence Address: PITNEY HARDIN LLP, 7 TIMES SQUARE, NEW YORK, NY, 10036-7311, US

(21) Appl. No.: 10/542,277

(22) PCT Filed: May 16, 2003
(86) PCT No.: PCT/JP03/06114

§ 371 Date: Jul. 14, 2005

(51) Int. Cl. G06F 17/00; H04L 9/00

(52) U.S. Cl. 700/94; 713/176

(57) ABSTRACT

The present invention relates to an audio digital watermark apparatus in which noise is not generated by embedding watermark data, which is resistant to modification caused by irreversible compression, into audio data, the embedding process of watermark data is reversible, and detection of watermark data is easy. The sound which is inaudible low-frequency is used as the data for generating a watermark and said data is multiplexed with the original audio data, so that it becomes possible to control and code the value of a predetermined summation of the multiplexed audio data. In detecting a watermark data, 0 or 1 of the watermark data is judged from the result of a predetermined summation per predetermined cycle of the multiplexed audio data with a watermark.

### BACKGROUND OF THE INVENTION

1. Field of the Invention

The present invention relates to an apparatus which embeds information such as copyright identification data as a digital watermark to audio data, and to an apparatus which detects and decrypts the digital watermark from the audio data, in which the digital watermark has been embedded.

2. Description of the Related Art

There exist many technologies for embedding watermarks in audio data such as music. However, in general, it is difficult to strike a balance between the sound quality and durability of a watermark. For example, in cases where watermark data is represented by some lower bits of sample data of audio data, noise will not be noticeable. However, if this information is represented as a high-frequency component in frequency conversion, it can easily be removed by compressing with compression software such as MP3. Moreover, there is a digital watermark, which is specific to MP3 compression from the beginning, such as a watermark in which coding is performed by using parity of a quantized frequency component. However, in many cases, the watermark information disappears in re-compression with a different data compression ratio. Further, there is a method of embedding watermark data by focusing on a compression method without degradation of sound quality. However, if it is converted into wave data, watermark information disappears. Besides, for example, there is a method of using statistical bias, etc. However, the more the number of samples for representing one bit in order to improve resistance of a watermark, the less data amount can be embedded. Meanwhile, the larger the bias becomes, the more resistant the watermark data becomes. However, the larger the bias becomes, the greater the degradation.

Thus, there has been no ideal digital watermark technology in which watermark data can be embedded without degradation of sound quality of original audio data, and the watermark data remains in spite of modification by irreversible data compression, etc., resulting in easy diction of the watermark data.

(The List of Cited Patent Documents)

Japanese Publication No. 2002-304184

In recent years, digitalization has proliferated, so that anyone can easily produce an exact copy of original audio data. Moreover, there have been many cases in which the data is compressed by compression software such as MP3 (MPEG Audio Layer 3), and distributed via the internet.

Such an act is less problematic with personal use, in which the user legally purchases the audio data and uses it personally; however, with illegal copying and distribution, it becomes a problem because it is difficult for a copyright holder to collect copyright royalty under such circumstances, thereby curtailing creative motivation.

In order to protect copyright from such fraudulent acts, there is a real need for a technology capable of embedding copyright information such as a watermark into the respective audio data.

### SUMMARY OF THE INVENTION

The first embodiment of the invention relates to an audio digital watermark apparatus for recording watermark data on a voice recording medium, which comprises:
an audio data acquisition unit, which acquires audio data;
a watermark data acquisition unit, which acquires watermark data;
a data generation unit for generating data for a watermark, which generates data for a watermark by multiplexing the audio data acquired by said audio data acquisition unit and the data for generating a watermark generated by said data generation unit for generating data for a watermark, wherein the result of a predetermined summation of multiplexed audio data per predetermined cycle represents the watermark data acquired by said watermark data acquisition unit; and
a multiplexed audio data generation unit, which generates multiplexed audio data by multiplexing the audio data acquired by said audio data acquisition unit and the data for generating a watermark generated by said data generation unit for generating data for a watermark.

The second embodiment of the invention relates to an audio digital watermark apparatus according to claim 1, wherein said data generation unit for generating data for a watermark generates the data for a watermark of inaudible low frequency.

The third embodiment of the invention relates to an audio digital watermark apparatus according to claim 1 or 2, wherein said data generation unit for generating data for a watermark generates the data for a watermark, in which the value and the slope of the boundary for changing the amplitude of a function of the data for generating a watermark, which is generated by the data generation unit for generating data for a watermark; are always zero.

The fourth embodiment of the invention relates to an audio digital watermark apparatus according to any one of claims 1 to 3, wherein said data generation unit for generating data for a watermark changes the amplitude of a function represented by said data for generating a watermark with respect to each half-cycle so that said result of the predetermined summation per said predetermined cycle represents the watermark data acquired by said watermark data acquisition unit.

The fifth embodiment of the invention relates to an audio digital watermark apparatus according to any one of claims 1 to 4, wherein said result of the predetermined summation per said predetermined cycle is a sign for the summation of said multiplexed audio data per half-cycle of said data for generating a watermark.

The sixth embodiment of the invention relates to an audio digital watermark apparatus according to any one of claims 1 to 4, wherein said result of the predetermined summation per said predetermined cycle is a sign representing the difference of the summation of said multiplexed audio data corresponding to the first half of the cycle and that of the latter half of said data for generating a watermark.

The seventh embodiment of the invention relates to an audio digital watermark decoding apparatus for decoding a watermark data recorded on an audio recording medium, which comprises:
a multiplexed audio data acquisition unit, which acquires-multiplexed audio data,
a summation computation unit, which computes the result of a predetermined summation of multiplexed audio data per said predetermined cycle, wherein said multiplexed audio data is acquired by the multiplexed audio data acquisition unit, and
a watermark data decoding unit, which decodes said watermark data based on said result of a predetermined summation computed by said summation computation unit.

The eighth embodiment of the invention relates to an audio digital watermark decoding apparatus according to claim 7, wherein said summation computation unit computes a sign for summation of said multiplexed audio data over a period of a half-cycle of said data for generating a watermark, in which said multiplexed audio data is acquired by the multiplexed audio data acquisition unit.

The ninth embodiment of the invention relates to an audio digital watermark decoding apparatus according to claim 7, wherein said summation computation unit computes a sign of the difference between the summation of said multiplexed audio data over a period of a half-cycle, the first half of one cycle, and a summation of said multiplexed audio data over a period of a half-cycle, the latter half thereof, in which said multiplexed audio data is acquired by said multiplexed audio data acquisition unit.

### BRIEF DESCRIPTION OF THE DRAWINGS

FIG. 1 is a functional block diagram of the first embodiment of the present invention.

FIG. 2 is an illustration of a waveform pattern of audio data which is acquired in the first embodiment.

FIG. 3 is an illustration of a waveform pattern of a base function of data for generating a watermark which is generated in the first embodiment.

FIG. 4 is an illustration of a sampling pattern of a base function of data for generating a watermark which is generated in the first embodiment.

FIG. 5 is an illustration of a waveform pattern of a data for generating a watermark of character “C” which is generated in the first embodiment.

FIG. 6 is an illustration of a process of embedding a watermark in the first embodiment.

FIG. 7 is an illustration of a process of the first embodiment.

FIG. 8 is a functional block diagram of the eighth embodiment of the present invention.

FIG. 9 is an illustration of a process of the second embodiment.

FIG. 10 is a functional block diagram of the tenth embodiment of the present invention.

FIG. 11 is an illustration of a waveform pattern of a base function of data for generating a watermark which is generated in the third embodiment.

FIG. 12 is an illustration of a process of the third embodiment.

FIG. 13 is a functional block diagram of the thirteenth embodiment of the present invention.

FIG. 14 is an illustration of a waveform pattern of a base function of data for generating a watermark which is generated in the fourth embodiment.

FIG. 15 is an illustration of a sampling pattern of a base function of data for generating a watermark which is generated in the fourth embodiment.

FIG. 16 is an illustration of a waveform pattern of a data for generating a watermark of character “C” which is generated in the fourth embodiment.

FIG. 17 is an illustration of a process of the fourth embodiment.

FIG. 18 is a functional block diagram of the eighteenth embodiment of the present invention.

FIG. 19 is an illustration of a process of embedding a watermark in the fifth embodiment.

FIG. 20 is an illustration of a process of the fifth embodiment.

FIG. 21 is a functional block diagram of the twenty-first embodiment of the present invention.

FIG. 22 is an illustration of a process of the sixth embodiment.

FIG. 23 is a functional block diagram of the twenty-third embodiment of the present invention.

FIG. 24 is an illustration of a process of detecting a watermark in the seventh embodiment.

FIG. 25 is an illustration of a process of the seventh embodiment.

FIG. 26 is a functional block diagram of the twenty-sixth embodiment of the present invention.

FIG. 27 is an illustration of a process of detecting a watermark in the eighth embodiment.

FIG. 28 is an illustration of a process of the eighth embodiment.

FIG. 29 is a functional block diagram of the twenty-ninth embodiment of the present invention.

FIG. 30 is an illustration of a process of detecting a watermark in the ninth embodiment.

FIG. 31 is an illustration of a process of the ninth embodiment.

### DETAILED DESCRIPTION OF THE PREFERRED EMBODIMENTS

Hereinafter, the embodiments of the present invention will be described. The relationships between the embodiments and claims are as indicated below.

In the first embodiment, claims 1 and 10 will be mainly described.

In the first embodiment, claims 2 and 11 will be mainly described.

In the first embodiment, claims 3 and 12 will be mainly described.

In the first embodiment, claims 4 and 13 will be mainly described.

In the first embodiment, claims 5 and 14 will be mainly described.

In the first embodiment, claims 6 and 15 will be mainly described.

In the first embodiment, claims 7 and 16 will be mainly described.

In the first embodiment, claims 8 and 17 will be mainly described.

In the first embodiment, claims 9 and 18 will be mainly described.

### The First Embodiment

The invention described in the first embodiment relates to an audio digital watermark apparatus which embeds watermark data such as copyright information by acquiring the copyright information as the watermark data, by multiplexing with audio data, and by using the result of a predetermined summation per predetermined cycle.

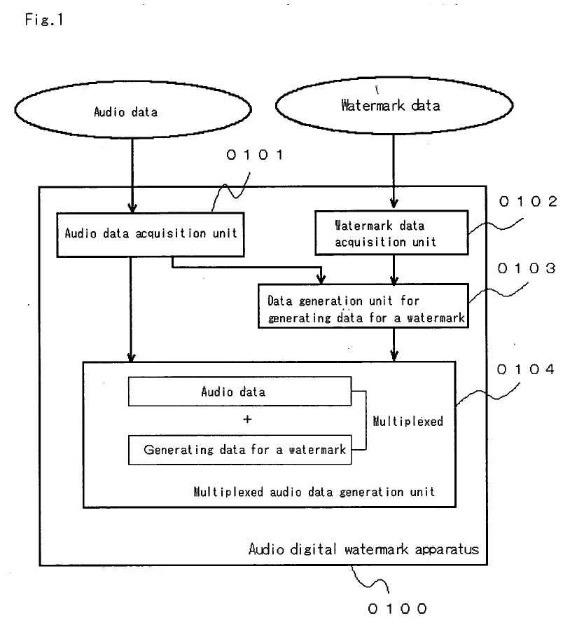

As shown in FIG. 1, the audio digital watermark apparatus 0100 of the first embodiment of the present invention comprises an audio data acquisition unit 0101, a watermark data acquisition unit 0102, a data generation unit for generating data for the watermark 0103, and a multiplexed audio data generation unit 0104.

(Audio Data Acquisition Unit)

An audio data acquisition unit acquires audio data.

(Watermark Data Acquisition Unit)

A watermark data acquisition unit acquires watermark data. Here, “watermark data” corresponds to the codes such as copyright identification information or digital data such as an ID used in content distribution.

(Data Generation Unit for Generating Data for a Watermark)

A data generation unit for generating data for a watermark which generates data for a watermark by multiplexing the audio data acquired by said audio data acquisition unit and the data for generating a watermark generated by said data generation unit for generating data for a watermark, wherein the result of a predetermined summation of multiplexed audio data per predetermined cycle represents the watermark data acquired by said watermark data acquisition unit.

Here, the “result of predetermined summation of multiplexed audio data per predetermined cycle” corresponds to the result of a predetermined summation of data for generating a watermark of multiplexed audio data per predetermined cycle. The “predetermined cycle” corresponds to a half-cycle, 1-cycle, 1.5-cycle, 2-cycle, 2.5-cycle, 3-cycle, and so on. The “predetermined summation” corresponds to the summation of a half-cycle and summation of one cycle etc. The “result of predetermined summation” corresponds to summation per half-cycle and per 1 cycle, a sign for summation, and a sign representing the difference between summations, etc.

(Multiplexed Audio Data Generation Unit)

A multiplexed audio data generation unit generates multiplexed audio data by multiplexing the audio data acquired by said audio data acquisition unit and the data for generating a watermark generated by said data generation unit for generating data for a watermark.

Hereinafter, the first embodiment of the present invention will be described by using concrete examples.

(Acquisition of Audio Data)

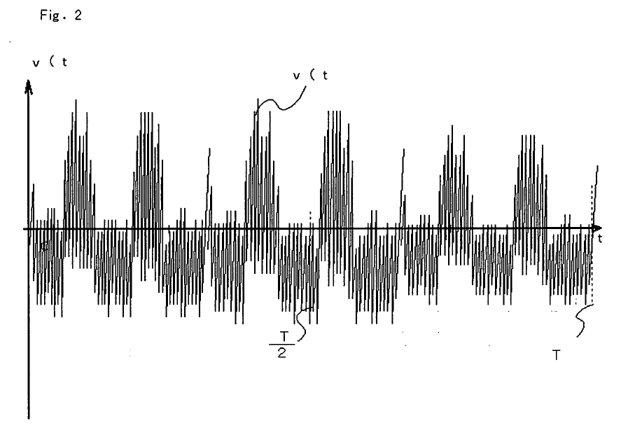

Audio data having a waveform as shown in FIG. 2 is acquired.

Note that digitalized audio data such as PCM (Pulse Code Modulation) may be acquired. Moreover, an analog waveform may be acquired and converted to digital data by sampling/quantization. Further, compressed audio data may be extracted as PCM data by decoding.

(Acquisition of Watermark Data)

Next, the watermark data may be any type of digital information such as codes and strings indicating copyright information, which are represented by binary numbers. For example, in cases where a string of letters is embedded without being compressed, it is converted to ASCII code and the value thereof is represented by a binary number.

Here, as an example, a case in which character “C” of “Copyright” is acquired as watermark data, will be described. The AACII code of this character is represented by a binary number such as “01000011”.

(Data for Generating a Watermark: Generation of a Base Function)

Next, a generation method of data for generating a watermark will be described. The watermark data is represented by a function in which a function of a basis (Hereinafter, referred to as a base function.) is multiplied by the amplitude A. For example, below is described a case in which the sampling rate of audio data is R Hz, and the wave of f Hz is used. Here, f is a set so that R/f is an integral number.

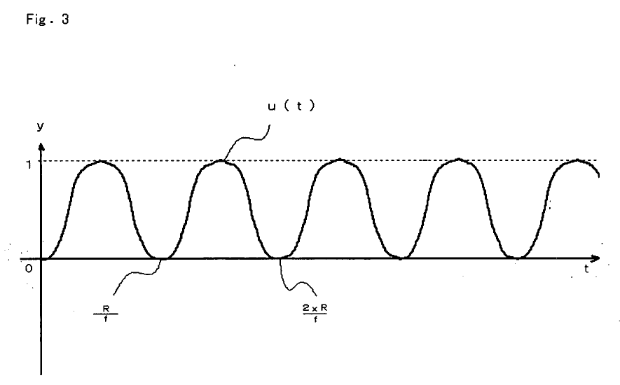

The base function u(t) is a function in which the above wave is sampled by sampling rate R. (Actually, sampling is not carried out, but derived by using a formula.) Here, t is a sample point. FIG. 3 illustrates an example of base function u(t), in which a sine-wave of cycle R/f is moved upward to adjust the maximum value to one and the minimum value to 0.

Since the above value of the function u(t) is frequently used, the value per one cycle is computed and a list of function values is pre-stored in memory.

Therefore, “u(0),u(1), . . . ,u(R/f−1)” are stored in the memory.

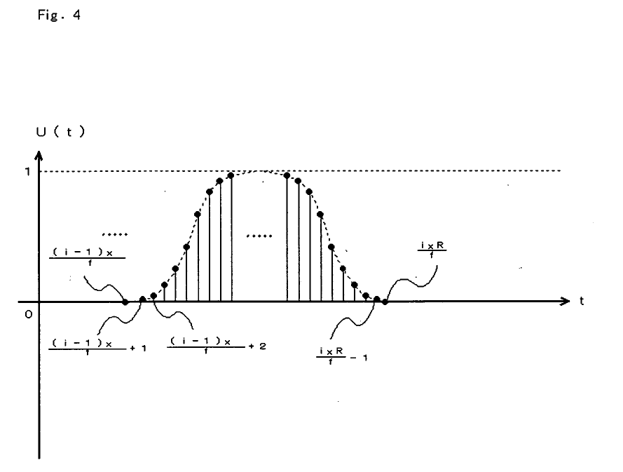

As shown in FIG. 4, a value at sample point t of the i-th cycle can be derived from said value per one cycle by using the following formula: u(t)=u (t−(i−1)·R/f).

(Data for Generating a Watermark: Computation of Summation)

The multiplexed audio data is generated by multiplexing said data for generating a watermark and original audio data. If a sample value of the original audio data is v(t), the multiplexed audio data becomes as below:
a(0)·u(0)+v(0), (1)
a(R/f)·u(R/f)+v(R/f), (2)
a(2·R/f−1)·u(2·R/f−1)+v(2·R/f−1), (3)
a(2·R/f)·u(2·R/f)+v(2·R/f), (4) and
a(3·R/f−1)·u(3·R/f−1)+v(3·R/f−1) (5).

If a sample value of the multiplexed audio data, which has been multiplexed with the data for generating a watermark, at the sample point t is w(t), the above example can be represented by the following formula: w(t)=v(t)+a(t)·u(t).

The above w(t) is added over one cycle of the i-th cycle. Here, a(t) is a certain value in one cycle. If this value is aᵢ, then Σw(t)=Σv(t)+aᵢ·Σu(t).

Here, Σ represents a summation per one cycle of the i-th cycle of data for generating a watermark.

Moreover, in the description hereinafter, the following formulae are formed:
Vᵢ=Σv(t), and U=Σu(t)

Generally, Vᵢ changes with respect to each i cycle, meanwhile, U is a constant. Also, the constant, U, is pre-stored in the memory.

(Data for Generating a Watermark: Generation of Amplitude)

Next, the value of aᵢ is set so that the absolute value of summation of the multiplexed audio data is a fixed value, and a sign thereof represents the bit-value of the watermark data. If the bit-value is b(0 or 1), and the absolute value of summation of the multiplexed audio data is S, and (−1)^{b}·S=Vᵢ+aᵢ·U

Therefore, the following formula is formed: aᵢ={(1)^{b}·S−Vᵢ}/U

Note that, in this example, one cycle represents one bit, so that the value of b changes as per i.

(Generation of Data for Generating a Watermark)

A function representing the data for generating a watermark, which is derived by multiplying the base function of the data for generating a watermark with amplitude aᵢ, is:
{(−1)^{b}·S−Vᵢ}·u(t)/U

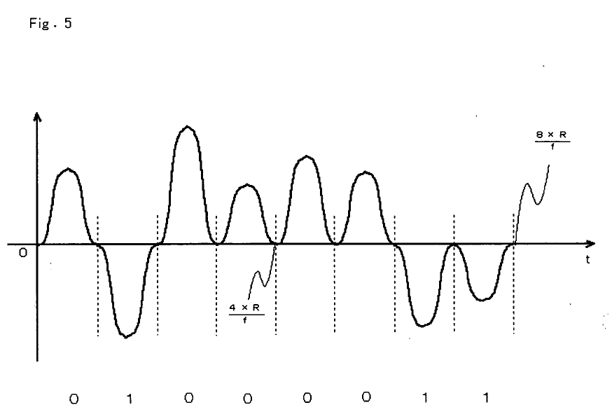

A schematic view of a waveform of the data for generating a watermark corresponding to character “C” of the watermark data is illustrated in FIG. 5. Note that, in FIG. 5, although the sign of amplitude aᵢ and the sign of (−1)^{b} are identical, they may be reversible according to the size of Vᵢ. The bit-value is represented not by the sign of amplitude of the data for generating a watermark, but by the sign of the summation of the multiplexed audio data.

(Generation of Multiplexed Audio Data)

Therefore, a relationship between the data for generating a watermark and the multiplexed audio data w(t) is: w(t)=v(t)+{(−1)^{b}·S−Vᵢ}·u(t)/U

(Process of Embedding a Digital Watermark)

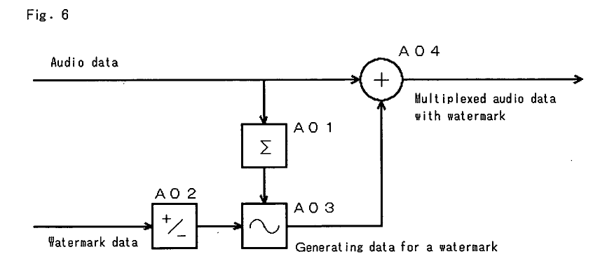

Next, by using the above formula, the process of embedding a digital watermark into audio data will be described with reference to FIG. 6. First, the audio data per one period of the data for generating the watermark is inputted to A02, and the summation of the above formula is computed and outputted to A03. Meanwhile, the watermark data is inputted to A02, and a sign of (−1)^{b} of the above formula is outputted to A03 per cycle of the data for generating a watermark. Therefore, in cases where the bit-value is 0, “+” sign is outputted, and in cases where the bit-value is 1, “−” sign is outputted. In A03, by using these two values, the data for generating a watermark is generated according to the above formula, and outputted to A04. In A04, by multiplexing this data for generating a watermark and the original audio data, multiplexed audio data with a watermark data is generated and outputted.

(Other Features)

The above process of embedding a watermark is reversible, so that it is possible to perfectly recover it if there is time-series data of amplitude of the data for generating a watermark which has been used in embedding the watermark data. Moreover, even if after watermark data has been embedded, or the other watermark data is embedded by the other, it is possible to extract each watermark data and recover the original audio data. Thus, it is able to embed a watermark several times over. Therefore, for example, it becomes possible to embed a unique ID of a content provider for the purpose of preventing fraudulent secondary distribution while protecting the copyright thereof after a copyright holder embeds information on the copyright.

Moreover, it is impossible to recover the original state of the data without the time-series data of amplitude of the data for generating a watermark which has been used in embedding the watermark data (since the bit-value is represented by the summation of multiplexed audio data, a method of decomposition to the original audio data and the data for generating a watermark is non-unique.). Therefore, by using the above aspect of the present invention, it is possible to establish a digital watermark system, which is highly resistant to falsification. For example, the above time-series data is outputted at the point of embedding the watermark data, and is stored in a place for managing the copyright. A person, who asserts the copyright of the audio data, brings the original audio data without a watermark, which is in his possession (asserted as such) to the place at which the copyright is administered, and composites said original audio data by using the time-series data of the amplitude of said data for generating a watermark. If the composite data is identical to the multiplexed data with the watermark, which has been distributed, it is authenticated as original data.

Note that although a description about the detection of the starting point of a watermark data or the error processing, etc. has not been described hereinabove, it is easy to implement them by using well-known prior art. For example, with regard to the detection of the starting point of the watermark data is implemented by pre-inserting a specific bit-pattern before the watermark data, and decoding immediately after that pattern is detected. In fact, there is a method wherein a point having 0 amplitude is skipped unconditionally, and a point synchronizing with a start-code is detected by moving the starting point by increments, after that, decoding is carried out by one cycle of the watermark data sequentially. With regard to the error processing, there is a method wherein a checksum, etc. are embedded as watermark data, and they are checked at the point of decoding.

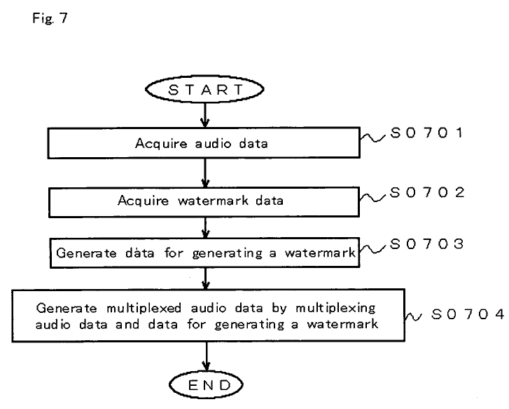

In FIG. 7, the process of the first embodiment is illustrated.

First, an audio data acquisition unit acquires audio data (Step S0701).

Second, a watermark data acquisition unit acquires watermark data (Step S0702).

Third, a data generation unit for generating data for a watermark generates data for a watermark (Step S0703) by multiplexing the audio data acquired by Step S0701 and the data for generating a watermark generated by Step S0702, wherein the result of a predetermined summation of multiplexed audio data per predetermined cycle represents the watermark data acquired by Step S0702.

Fourth, a multiplexed audio data generation unit generates multiplexed audio data (Step S0704) by multiplexing the audio data acquired by Step S0701 and the data for generating a watermark generated by Step S0703.

According to the first embodiment of the present invention, it becomes possible to prevent degradation of sound quality in embedding a watermark data by using a method wherein copyright information, etc. are acquired as watermark data and multiplexed with the audio data to be multiplexed audio data, so that the watermark information is represented by the result of a predetermined summation per predetermined cycle.

Moreover, since one bit is encoded at one wavelength of data for generating a watermark, if the data for generating a watermark has a long wavelength, it becomes possible to embed a large amount of watermark data effectively.

### The Second Embodiment

The second embodiment of the present invention relates to the audio digital watermark apparatus according to claim 1, wherein said data generation unit for generating data for a watermark generates the data for a watermark of inaudible low frequency.

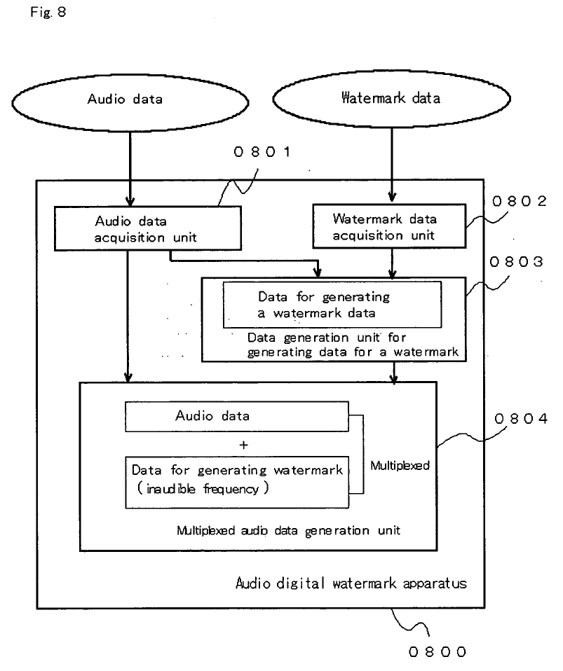

As shown in FIG. 8, the audio digital watermark apparatus 0800 of the second embodiment of the present invention comprises an audio data acquisition unit 0801, a watermark data acquisition unit 0802, a data generation unit for generating data for a watermark 0803, and a multiplexed audio data generation unit 0804.

(Audio Data Acquisition Unit)

The audio data acquisition unit is the same as the audio data acquisition unit in the first embodiment of the present invention, so that the description thereof is omitted.

(Watermark Data Acquisition Unit)

The watermark data acquisition unit is the same as the (Watermark data acquisition unit) in the first embodiment of the present invention, so that the description thereof is omitted.

(Data Generation Unit for Generating Data for a Watermark)

The data generation unit for generating data for a watermark generates the data for a watermark of inaudible low frequency. Here, “inaudible low frequency” corresponds to a low frequency below 20 Hz.

The other features are the same as the data generation unit for generating data for a watermark in the first embodiment of the present invention, so that the description thereof is omitted.

(Multiplexed Audio Data Generation Unit)

The multiplexed audio data generation unit is the same as the multiplexed audio data generation unit) in the first embodiment of the present invention, so that the description thereof is omitted.

Hereinafter, the second embodiment of the present invention will be described by using concrete examples.

(Acquisition of Audio Data)

Acquisition of audio data is the same as the acquisition of audio data in the first embodiment of the present invention, so that the description thereof is omitted.

(Acquisition of Watermark Data)

Acquisition of watermark data is the same as the acquisition of watermark data in the first embodiment of the present invention, so that the description thereof is omitted.

(Data for Generating a Watermark: Generation of Base Function)

In the second embodiment of the present invention, inaudible low frequency is used for the data for generating a watermark. In an example, the sampling-rate is 44.1 kHz, a function of 10 Hz is used as data for generating a watermark, and the base function u(t) is a function of which cycle is 44.1 kHz/10.

In the second embodiment, R=44.1 kHz, f=10 (R and f are defined in the first embodiment.) The other features are the same as the data for generating a watermark (generation of a base function) in the first embodiment of the present invention, so that the description thereof is omitted.

(Data for Generating a Watermark: Computation of Summation)

In the second embodiment, R=44.1 kHz, f=10 (R and f are defined in the first embodiment.) The other features are the same as the data for generating a watermark: computation of summation in the first embodiment of the present invention, so that the description thereof is omitted.

(Data for Generating a Watermark: Generation of Amplitude)

In the second embodiment, R=44.1 kHz, f=10 (R and f are defined in the first embodiment.) The other features are the same as the data for generating a watermark: generation of amplitude in the first embodiment of the present invention, so that the description thereof is omitted.

(Generation of Data for Generating a Watermark)

In the second embodiment, R=44.1 kHz, f=10 (R and f are defined in the first embodiment.) The other features are the same as the generation of data for generating a watermark in the first embodiment of the present invention, so that the description thereof is omitted.

(Generation of Multiplexed Audio Data)

Generation of multiplexed audio data in the second embodiment of the present invention is the same as the generation of multiplexed audio data in the first embodiment of the present invention, so that the description thereof is omitted.

(Process of Embedding a Digital Watermark)

Process of embedding a digital watermark in the second embodiment of the present invention is the same as the process of embedding a digital watermark in the first embodiment of the present invention, so that the description thereof is omitted.

(Other Features)

The other features in the second embodiment of the present invention are the same as the other features in the first embodiment of the present invention, so that the description thereof is omitted.

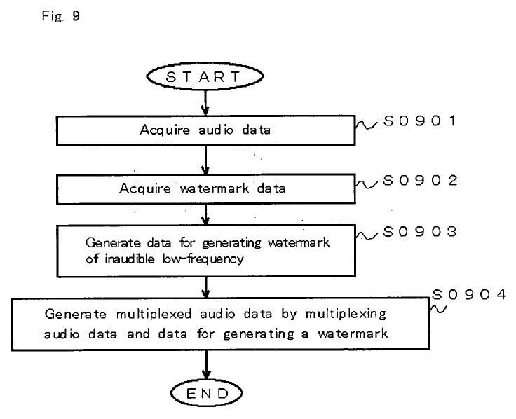

In FIG. 9, the process of the second embodiment is illustrated.

First, an audio data acquisition unit acquires audio data (Step S0901). Second, a watermark data acquisition unit acquires watermark data (Step S0902).

Third, a data generation unit for generating data for a watermark generates data for a watermark of inaudible low-frequency (Step S0903) by multiplexing the audio data acquired by Step S0901 and the data for generating a watermark generated by Step S0902, wherein the result of a predetermined summation of multiplexed audio data per predetermined cycle represents the watermark data acquired by Step S0902.

Fourth, a multiplexed audio data generation unit generates multiplexed audio data (Step S0904) by multiplexing the audio data acquired by Step S0901 and the data for generating a watermark generated by Step S0903.

According to the second embodiment of the present invention, since the data of inaudible low-frequency is used as data for generating a watermark, even if the amplitude of data for generating a watermark is wide, it becomes possible to implement a robust digital watermark without degradation of sound quality of the original audio data.

Moreover, since one bit is encoded at one wavelength of data for generating a watermark, if the data for generating a watermark has a long wavelength, it becomes possible to embed a large amount of watermark data effectively.

### The Third Embodiment

The third embodiment of the present invention relates to the audio digital watermark apparatus according to claim 1 or 2, wherein a function, in which a value and a slope of a boundary for changing an amplitude thereof are always zero, is used as a function representing data for generating a watermark.

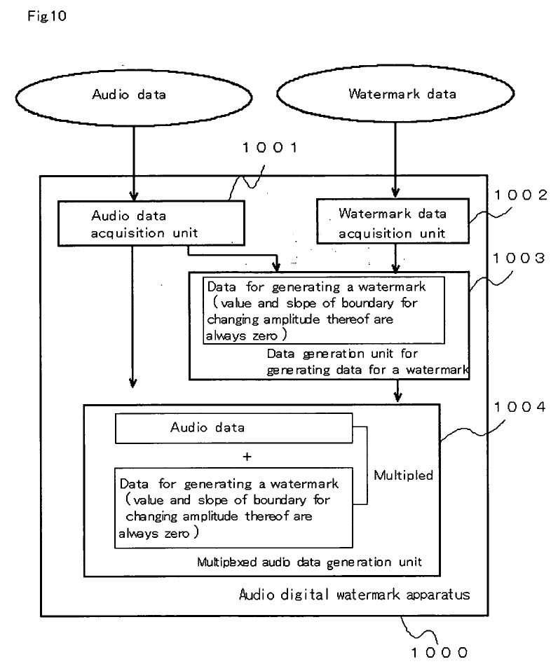

As shown in FIG. 10, the audio digital watermark apparatus 1000 of the third embodiment of the present invention comprises an audio data acquisition unit 1001, a watermark data acquisition unit 1002, a data generation unit for generating data for a watermark 1003, and a multiplexed audio data generation unit 1004.

(Audio Data Acquisition Unit)

The audio data acquisition unit is the same as the audio data acquisition unit in the first or second embodiment of the present invention, so that the description thereof is omitted.

(Watermark Data Acquisition Unit)

The watermark data acquisition unit is the same as the watermark data acquisition unit in the first or second embodiment of the present invention, so that the description thereof is omitted.

(Data Generation Unit for Generating Data for a Watermark)

The data generation unit for generating data for a watermark generates the data for a watermark, in which the value and the slope of the boundary for changing the amplitude of a function of the data for generating a watermark, which is generated by the data generation unit for generating data for a watermark, are always zero.

The other features are the same as the data generation unit for generating data for a watermark in the first or second embodiment of the present invention, so that the description thereof is omitted.

(Multiplexed Audio Data Generation Unit)

The multiplexed audio data generation unit is the same as the multiplexed audio data generation unit in the first or second embodiment of the present invention, so that the description thereof is omitted.

Hereinafter, the third embodiment of the present invention will be described by using concrete examples.

(Acquisition of Audio Data)

Acquisition of audio data is the same as the acquisition of audio data in the first or second embodiment of the present invention, so that the description thereof is omitted.

(Acquisition of Watermark Data)

Acquisition of watermark data is the same as the acquisition of watermark data in the first or second embodiment of the present invention, so that the description thereof is omitted.

(Data for Generating a Watermark: Generation of Base Function)

In the third embodiment of the present invention, a function, in which the value and the slope of the boundary for changing the amplitude thereof are always zero, is used as a function representing data for generating a watermark. Therefore, the following function, in which the value and the slope of the boundary for changing the amplitude thereof are zero, is used as the base function u(x) of the data for generating a watermark: u(xₙ)=u′(xₙ)=0

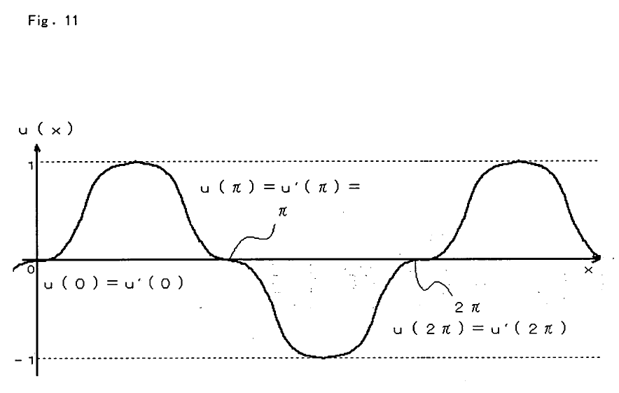

Here, xₙ is the n-th boundary point for changing said amplitude. In FIG. 11, a case in which xₙ=n·π(n is an integral number) is illustrated.

The other features are the same as the (Data for generating a watermark: generation of base function) in the first or second embodiment of the present invention, so that the description thereof is omitted.

(Data for Generating a Watermark: Computation of Summation)

In the third embodiment, the base function u(x) fulfills conditions of (Data for generating a watermark: generation of base function).

The other features are the same as those of the data for generating a watermark (computation of summation) in the first or second embodiment of the present invention, so that the description thereof is omitted.

(Data for Generating a Watermark: Generation of Amplitude)

In the third embodiment, the base function, u(x), fulfills the conditions of the data for generating a watermark (generation of base function).

The other features are the same as those of the data for generating a watermark (generation of amplitude) in the first embodiment of the present invention, so that the description thereof is omitted.

(Generation of Data for Generating a Watermark)

Generation of data for generating a watermark in the third embodiment of the present invention is the same as the generation of data for generating a watermark in the first or second embodiment of the present invention, so that the description thereof is omitted.

(Generation of Multiplexed Audio Data)

In the third embodiment, the base function, u(x), fulfills the conditions of the data for generating a watermark (generation of base function).

The other features are the same as those of the generation of multiplexed audio data in the first or second embodiment of the present invention, so that the description thereof is omitted.

(Process of Embedding a Digital Watermark)

The process of embedding a digital watermark in the third embodiment of the present invention is the same as the process of embedding a digital watermark in the first or second embodiment of the present invention, so that the description thereof is omitted.

(Other Features)

The other features in the third embodiment of the present invention are the same as the other features in the first or second embodiment of the present invention, so that the description thereof is omitted.

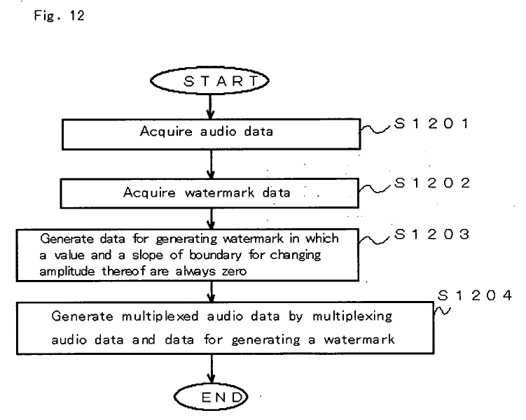

In FIG. 12, the process of the third embodiment is illustrated.

First, an audio data acquisition unit acquires audio data (Step S1201).

Second, a watermark data acquisition unit acquires watermark data (Step S1202).

Third, a data generation unit for generating data for a watermark generates data for a watermark, in which the value and the slope of the boundary for changing the amplitude thereof are always zero, by multiplexing the audio data acquired by Step S1201 and the data for generating a watermark generated by Step S1202, wherein the result of a predetermined summation of multiplexed audio data per predetermined cycle represents the watermark data acquired by Step S1202 (Step S1203).

Fourth, a multiplexed audio data generation unit generates multiplexed audio data (Step S1204) by multiplexing the audio data acquired by Step S1201 and the data for generating a watermark generated by Step S1203.

According to the third embodiment of the present invention, since the value and the slope of the boundary for changing the amplitude of a function, which is represented by data for generating a watermark, are always zero, even if the amplitude changes, said function continues smoothly, so that it becomes possible to prevent generation of high-frequency noise.

Moreover, since one-bit is encoded at one wavelength of data for generating a watermark, if the data for generating a watermark has long wavelength, it becomes possible to embed a large amount of watermark data effectively.

### The Fourth Embodiment

The fourth embodiment of the present invention relates to the audio digital watermark apparatus according to any one of claims 1 to 3, wherein said data generation unit for generating data for a watermark changes the amplitude of a function represented by said data for generating a watermark with respect to each half-cycle so that said result of the predetermined summation per said predetermined cycle represents the watermark data acquired by said watermark data acquisition unit.

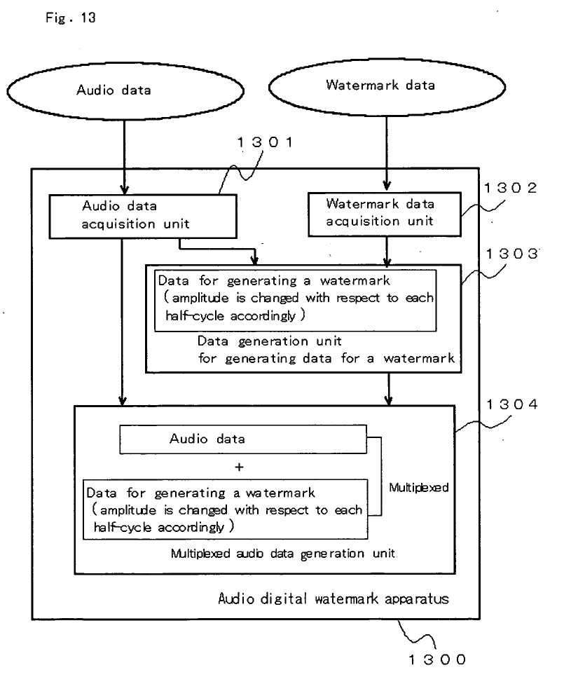

As shown in FIG. 13, the audio digital watermark apparatus 1300 of the fourth embodiment of the present invention comprises an audio data acquisition unit 1301, a watermark data acquisition unit 1302, a data generation unit for generating data for a watermark 1303, and a multiplexed audio data generation unit 1304.

(Audio Data Acquisition Unit)

The audio data acquisition unit is the same as the audio data acquisition unit in any one of the first to third embodiments of the present invention, so that the description thereof is omitted.

(Watermark Data Acquisition Unit)

The watermark data acquisition unit is the same as the watermark data acquisition unit in any one of the first to third embodiments of the present invention, so that the description thereof is omitted.

(Data Generation Unit for Generating Data for a Watermark)

The data generation unit for generating data for a watermark data generation unit for generating data for a watermark changes the amplitude of a function represented by said data for generating a watermark with respect to each half-cycle so that said result of the predetermined summation per said predetermined cycle represents the watermark data acquired by said watermark data acquisition unit.

The other features are the same as those of the data generation unit for generating data for a watermark in any one of the first to third embodiments of the present invention, so that the description thereof is omitted.

(Multiplexed Audio Data Generation Unit)

The multiplexed audio data generation unit is the same as the multiplexed audio data generation unit in any one of the first to third embodiments of the present invention, so that the description thereof is omitted.

Hereinafter, the fourth embodiment of the present invention will be described by using concrete examples.

(Acquisition of Audio Data)

Acquisition of audio data is the same as the acquisition of audio data in any one of the first to third embodiments of the present invention, so that the description thereof is omitted.

(Acquisition of Watermark Data)

Acquisition of watermark data is the same as the acquisition of watermark data in any one of the first to third embodiments of the present invention, so that the description thereof is omitted.

(Data for Generating a Watermark: Generation of Base Function)

Next, a generation method of data for generating a watermark will be described. The watermark data is represented by a function in which a function of a basis (hereinafter, referred to as a base function.) is multiplied by amplitude A. As an example, the following function u(t) is described:
u(t)=sin³(2π·f·t/R)=(3/4)·sin(2π·f·t/R)−(1/4)·sin(3·2π·f·t/R)

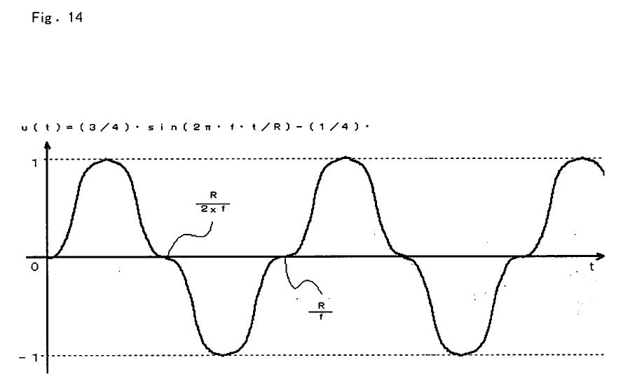

As shown in FIG. 14, the function value and slope of the above function are zero at each half-cycle. Therefore, if the amplitude is changed around the point in which the value and slope of the above function are zero at each half-cycle, the function smoothly continues, so that it becomes possible to prevent generation of high-frequency noise.

Note that, although a frequency of 3f/R and a frequency of f/R are included in the above function, the amplitude of the frequency of 3f/R is ⅓ of the frequency of f/R, so that it is inaudible.

Since the above value of function u(t) is always used, the value per half-cycle is computed and a list of the function values is pre-stored in memory. As an example, the following formula is stored in the memory: u(0),u(1), . . . ,u(R/f/2−1).

Moreover, the following value as per latter-half of a cycle is a value in which the sign thereof is the inverted sign of the value as per first-half of a cycle u(R/f/2),u(R/f/2+1), . . . ,u(R/f−1)

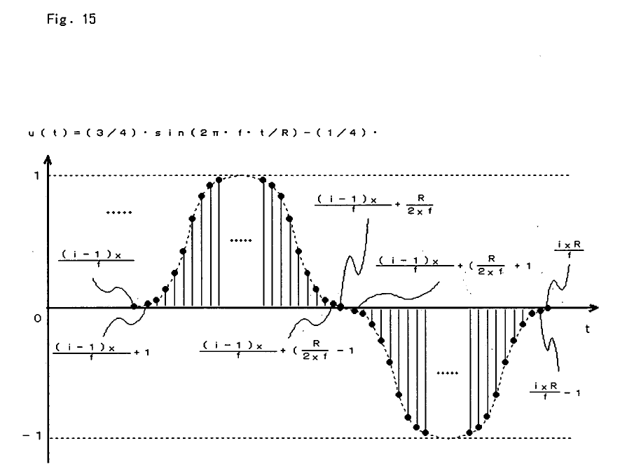

Moreover, as shown in FIG. 15, the values of sample point t of the i-th cycle can be derived from the above list of function values by using the following formula:
u(t)=u(t−(i−1)·R/f), (1)
t=(i−1)·R/f,(i−1)·R/f+1, (2)
(i−1)·R+(R/f/2−1),(i−1)·R+R/f/2, (3)
i·R/f−1 (4)

(Data for Generating a Watermark: Computation of Summation)

If the sample value of sample point t of the multiplexed audio data with the data for generating a watermark is w(t), the following formula is formed: w(t)=v(t)+a(t)−u(t)

If this w(t) is added over a half-cycle of the i-th cycle, the value of a(t) becomes a fixed value. If this fixed value is aᵢ, the following formula is formed: Σw(t)=Σv(t)+aᵢ·Σu(t)

Here, Σ represents a summation per half-cycle of the i-th cycle of data for generating a watermark.

Moreover, there are the following equations in the description hereinafter for the first half-cycle of i-th cycle:
V₁ᵢ=Σv(t)
U₁=Σu(t)
a₁ᵢ=aᵢ
Moreover, there are the following equations for the latter half-cycle of i-th cycle:
V₂ᵢ=Σv(t)
U₂=Σu(t)
a₂ᵢ=aᵢ
V₁ᵢ, V₂ᵢ generally changes each i cycle, and U₁, U₂ are fixed numbers (in the above example, U₁=−U₂). These fixed numbers, U₁, U₂, are also stored in memory.

(Data for Generating a Watermark: Generation of Amplitude)

Next, the values of a₁ᵢ, a₂ᵢ are fixed so that the absolute value of summation of the multiplexed audio data per half-cycle of the data for generating a watermark is fixed, and the sign thereof represents a bit-value of the watermark data. Here, the sign for summation of the multiplexed audio data per latter half-cycle of the data for generating a watermark is reversion of the sign for summation of the multiplexed audio data per first-half cycle of the data for generating a watermark. If the bit-value is b(0 or 1), and the absolute value of summation of the multiplexed audio data is S, the first-half cycle of i-th cycle is “Σw(t)=(−1)^{b}·S=V₁ᵢ+a₁ᵢ·U₁,” and the latter half-cycle of i-th cycle is “Σw(t)=−(−1)^{b}·S=V₂ᵢ+a₂ᵢ·U₂.”

Therefore, the following formulae are formed for the first-half cycle of the i-th cycle:
a₁ᵢ={(−1)^{b}·S−V₁ᵢ}/U₁, and
for the latter half-cycle of i-th cycle is:
a₂ᵢ={−(−1)^{b}·S−V₂ᵢ}/U2.

Note that, in this example, one cycle represents one bit, so that the value of b generally changes at each i.

(Generation of Data for Generating a Watermark)

The function representing the data for generating a watermark, which is derived by multiplying the base function of the data for generating a watermark with the amplitude a₁, a₂ᵢ is as follows for the first-half cycle of i-th cycle:
{{(−1)^{b}·S−V₁ᵢ}/U₁}·u(t), and for
the latter half-cycle of the i-th cycle:
{{−(−1)^{b}S−V₂ᵢ}/U₂}·u(t)

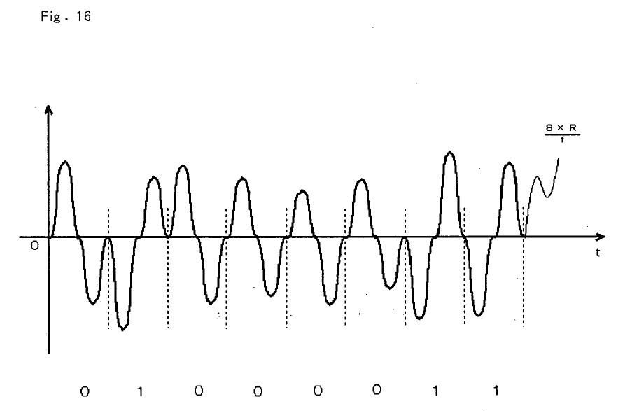

A schematic view of a waveform of the data for generating a watermark corresponding to character “C” of the watermark data is illustrated in FIG. 16. Note that, in FIG. 16, although the sign for the data for generating a watermark corresponds to the bit-value, they may be reversible according to the size of V₁ᵢ and V₂ᵢ. The sign corresponding to the bit-value is not the sign of amplitude of the data for generating a watermark, but the sign for the summation of the multiplexed audio data.

(Generation of Multiplexed Audio Data)

Therefore, the relationship between the data for generating a watermark and the multiplexed audio data w(t) are for the first-half cycle of the i-th cycle:
w(t)=v(t)+{{(−1)^{b}·S−V₁ᵢ}/U₁}·u(t), and for
the latter half-cycle of i-th cycle:
w(t)=v(t)+{{−(−1)^{b}·S−V₂ᵢ}/U₂} u(t).

(Other Features)

The other features in the second embodiment of the present invention are the same as the other features in the first embodiment of the present invention, so that the description thereof is omitted.

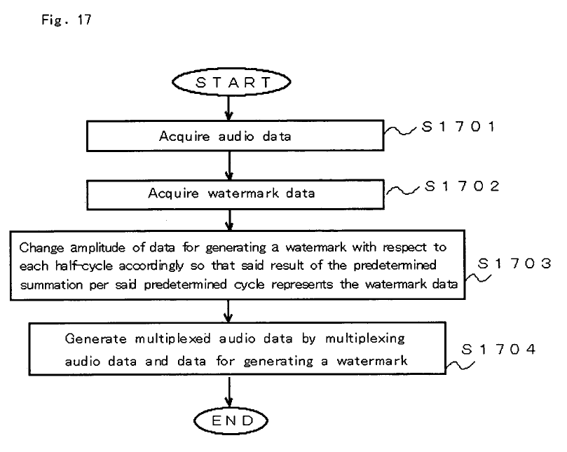

In FIG. 17, the process of the fourth embodiment is illustrated.

First, an audio data acquisition unit acquires audio data (Step S1701).

Second, a watermark data acquisition unit acquires watermark data (Step S1702).

Third, a data generation unit for generating data for a watermark changes the amplitude of the data for generating a watermark with respect to each half-cycle so that said result of the predetermined summation per said predetermined cycle represents: the watermark data acquired by Step S1702 (Step S1703).

Fourth, a multiplexed audio data generation unit generates multiplexed audio data (Step S1704) by multiplexing the audio data acquired by Step S1701 and the data for generating a watermark generated by Step S1703.

According to the fourth embodiment of the present invention, the sign for summation per predetermined cycle is reversed each time, so that it becomes possible to prevent residual of DC offset.

### The Fifth Embodiment

The fifth embodiment of the present invention relates to the audio digital watermark apparatus according to any one of claims 1 to 4, wherein said result of the predetermined summation per said predetermined cycle is a sign for a summation of said multiplexed audio data per half-cycle of said data for generating a watermark.

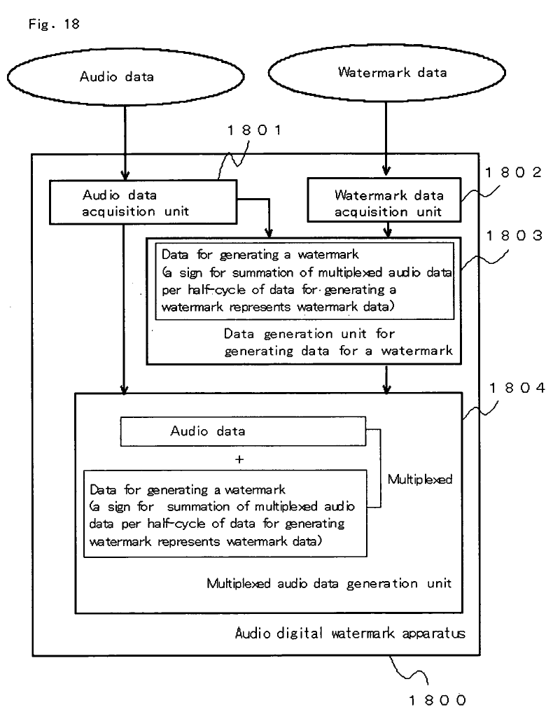

As shown in FIG. 18, the audio digital watermark apparatus 1800 of the fifth embodiment of the present invention comprises an audio data acquisition unit 1801, a watermark data acquisition unit 1802, a data generation unit for generating data for a watermark 1803, and a multiplexed audio data generation unit 1804.

(Audio Data Acquisition Unit)

The audio data acquisition unit is the same as the audio data acquisition unit in the fourth embodiment of the present invention, so that the description thereof is omitted.

(Watermark Data Acquisition Unit)

The watermark data acquisition unit is the same as the watermark data acquisition unit in the fifth embodiment of the present invention, so that the description thereof is omitted.

(Data Generation Unit for Generating Data for a Watermark)

The data generation unit for generating data for a watermark generates the data for a watermark; so that the result of the predetermined summation per predetermined cycle of multiplexed audio data represents the watermark data acquired by the watermark data acquisition unit.

Here, “the result of the predetermined summation per predetermined cycle” corresponds to the sign for the summation of the multiplexed audio data per half-cycle of the data for generating a watermark.

The other features are the same as the data generation unit for generating data for a watermark in the fourth embodiment of the present invention, so that the description thereof is omitted.

(Multiplexed Audio Data Generation Unit)

The multiplexed audio data generation unit is the same as the multiplexed audio data generation unit in the fourth embodiment of the present invention, so that the description thereof is omitted.

Hereinafter, the fifth embodiment of the present invention will be described by using concrete examples.

(Acquisition of Audio Data)

Acquisition of audio data is the same as the acquisition of audio data in the fourth embodiment of the present invention, so that the description thereof is omitted.

(Acquisition of Watermark Data)

Acquisition of watermark data is the same as the acquisition of watermark data in the fourth embodiment of the present invention, so that the description thereof is omitted.

(Data for Generating a Watermark: Generation of Base Function)

Generation of a base function is the same as the data for generating a watermark (generation of base function) in the fourth embodiment of the present invention, so that the description thereof is omitted.

(Data for Generating a Watermark: Computation of Summation)

Computation of summation is the same as the data for generating a watermark (computation of summation) in the fourth embodiment of the present invention, so that the description thereof is omitted.

(Data for Generating a Watermark: Generation of Amplitude)

In the description of the data for generating a watermark (generation of amplitude) in the fourth embodiment of the present invention, the equation for the first-half cycle of the i-th cycle is:

Σw(t)=(−1)^{b}·S, and for

the latter-half cycle of the i-th cycle is:
Σw(t)=−(−1)^{b}·S
Here, by computing the summation of the multiplexed audio data per half-cycle (per first-half cycle or per later-half cycle) of the data for generating a watermark, the sign thereof is derived, so that it becomes possible to judge 0 or 1 of each bit of the watermark data. Therefore, the amplitude can be generated by the same method described in the fourth embodiment of the present invention.

(Generation of Data for Generating a Watermark)

Generation of data for generating a watermark is the same as the generation of data for generating a watermark in the first or second embodiment of the present invention, so that the description thereof is omitted.

(Generation of Multiplexed Audio Data)

Generation of multiplexed audio data is the same as the generation of multiplexed audio data in the fourth embodiment of the present invention, so that the description thereof is omitted.

(Process of Embedding a Digital Watermark)

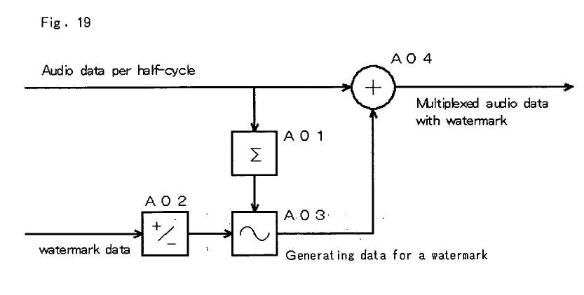

Next, by using the above formula, the process of embedding a digital watermark into audio data will be described by referring to FIG. 19. First, the audio data per half-period of the data for generating the watermark is inputted to A01, and the summation of the above formula is computed and outputted to A03. Meanwhile, the watermark data is inputted to A02, and a sign of (−1)^{b} or −(−1)^{b} of the above formula is outputted to A03 with respect to each cycle of the data for generating a watermark. Therefore, in the first-half cycle, in cases where the bit-value is 0, a “+” sign is outputted, and in cases where the bit-value is 1, a “−” sign is outputted. Meanwhile, in the latter-half cycle, in cases where the bit-value is 0, a “−” sign is outputted, and in cases where the bit-value is 1, a “+” sign is outputted. In A03, by using these two values, the data for generating a watermark is generated according to the above formula, and outputted to A04. In A04, by multiplexing this data for generating a watermark and the original audio data, multiplexed audio data with watermark data is generated and outputted.

(Other Features)

The other features are the same as the other features in the first embodiment of the present invention, so that the description thereof is omitted.

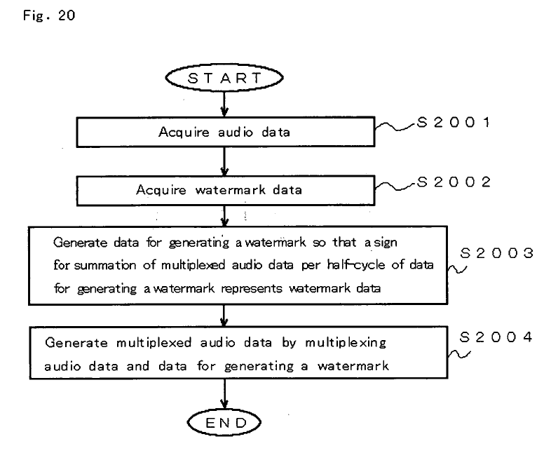

In FIG. 20, the process of the fifth embodiment is illustrated.

First, an audio data acquisition unit acquires audio data (Step S2001).

Second, a watermark data acquisition unit acquires watermark data (Step S2002).

Third, a data generation unit for generating data for a watermark generates a data for generating a watermark so that the sign for the summation of multiplexed audio data per half-cycle of data for generating a watermark represents the watermark data acquired by Step S2002 (Step S2003).

Fourth, a multiplexed audio data generation unit generates multiplexed audio data by multiplexing the audio data acquired by Step S2001 and the data for generating a watermark generated by Step S2003 (Step S2004).

According to the fifth embodiment of the present invention, a sign for the summation of multiplexed audio data per half-cycle of data for generating a watermark represents 0 or 1 of each bit of watermark data, thereby enabling easy detection/decoding of watermark data. Moreover, the absolute value of the summation is always fixed and not zero, so that it becomes possible to implement a digital watermark which is resistant to the modification of audio data.

### The Sixth Embodiment

The sixth embodiment of the present invention relates to the audio digital watermark apparatus according to any one of claims 1 to 4, wherein the result of the predetermined summation per predetermined cycle is a sign representing the difference between the summation of said multiplexed audio data corresponding to the first-half cycle of the data for generating a watermark and the summation of said multiplexed audio data corresponding to the latter-half cycle of the data for generating a watermark.

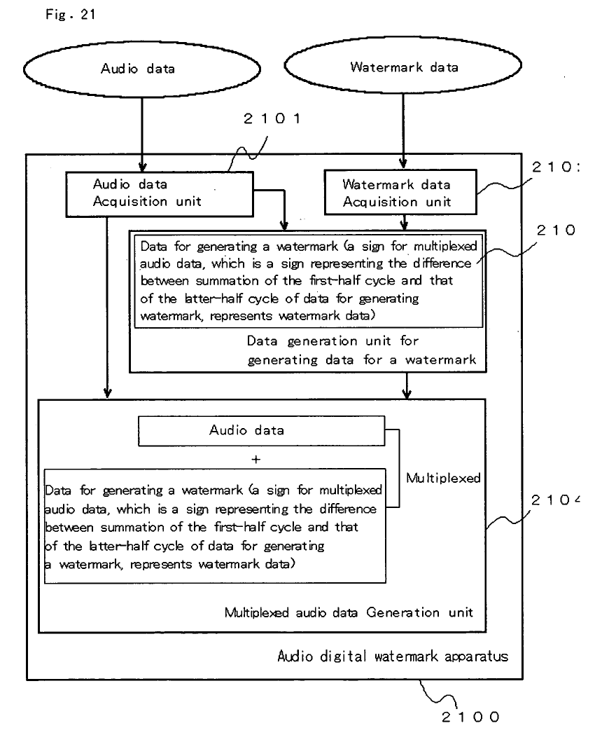

As shown in FIG. 21, the audio digital watermark apparatus 2100 of the sixth embodiment of the present invention comprises an audio data acquisition unit 2101, a watermark data acquisition unit 2102, a data generation unit for generating data for a watermark 2103, and a multiplexed audio data generation unit 2104.

(Audio Data Acquisition Unit)

The audio data acquisition unit is the same as the audio data acquisition unit in the fourth embodiment of the present invention, so that the description thereof is omitted.

(Watermark Data Acquisition Unit)

The watermark data acquisition unit is the same as the watermark data acquisition unit in the fourth embodiment of the present invention, so that the description thereof is omitted.

(Data Generation Unit for Generating Data for a Watermark)

The data generation unit for generating data for a watermark correspondingly changes the amplitude of data for generating a watermark per half-cycle so that the result of the predetermined summation per predetermined cycle represents the watermark data acquired by said watermark data acquisition unit. Here, “the result of the predetermined summation per predetermined cycle” corresponds to the sign of the difference between the summation of said multiplexed audio data corresponding to the first-half cycle of the data for generating a watermark and the summation of said multiplexed audio data corresponding to the latter-half cycle of the data for generating a watermark.

(Multiplexed Audio Data Generation Unit)

The multiplexed audio data generation unit is the same as the multiplexed audio data generation unit in the fourth embodiment of the present invention, so that the description thereof is omitted.

Hereinafter, the sixth embodiment of the present invention will be described by using concrete examples.

(Acquisition of Audio Data)

Acquisition of audio data is the same as the acquisition of audio data in the fourth embodiment of the present invention, so that the description thereof is omitted.

(Acquisition of Watermark Data)

Acquisition of watermark data is the same as the acquisition of watermark data in the fourth embodiment of the present invention, so that the description thereof is omitted.

(Data for Generating a Watermark: Generation of Base Function)

Generation of base function is the same as the data for generating a watermark: generation of base function in the fourth embodiment of the present invention, so that the description thereof is omitted.

(Data for Generating a Watermark: Computation of Summation)

Computation of summation is the same as the data for generating a watermark: computation of summation in the fourth embodiment of the present invention, so that the description thereof is omitted.

(Data for Generating a Watermark: Generation of Amplitude)

In the description of data for generating a watermark: generation of amplitude in the fourth embodiment of the present invention, the equation is as follows for the first-half cycle of the i-th cycle:
Σw(t)=(−1)^{b}·S, and for
the latter-half cycle of the i-th cycle:
Σw(t)=−(−1)^{b}·S
Here, the difference between the summation of said multiplexed audio data corresponding to the first-half cycle of the data for generating a watermark and the summation of said multiplexed audio data corresponding to the later-half cycle of the data for generating a watermark is: (−1)^{b} 2S. By the sign thereof, it becomes possible to judge 0 or 1 of each bit of the watermark data. Therefore, the amplitude can be generated by the same method described in the fourth embodiment of the present invention.

(Generation of Data for Generating a Watermark)

Generation of data for generating a watermark is the same as the generation of data for generating a watermark in the fourth embodiment of the present invention, so that the description thereof is omitted.

(Generation of Multiplexed Audio Data)

Generation of multiplexed audio data is the same as the generation of multiplexed audio data in the fourth embodiment of the present invention, so that the description thereof is omitted.

(Process of Embedding a Digital Watermark)

Process of embedding a digital watermark is the same as the process of embedding a digital watermark in the fifth embodiment of the present invention, so that the description thereof is omitted.

(Other Features)

The other features are the same as the other features in the first embodiment of the present invention, so that the description thereof is omitted.

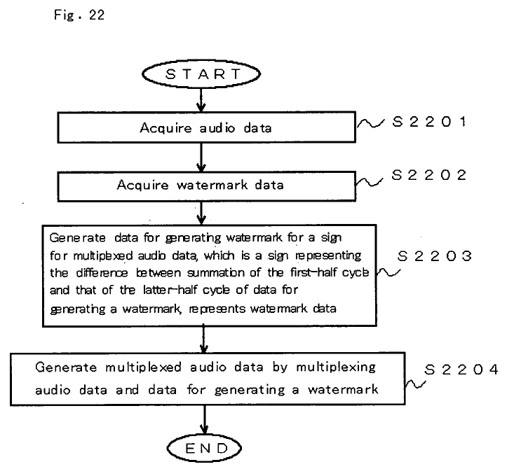

In FIG. 22, the process of the sixth embodiment is illustrated.

First, an audio data acquisition unit acquires audio data (Step S2201).

Second, a watermark data acquisition unit acquires watermark data (Step S2202).

Third, a data generation unit for generating data for a watermark generates data for generating a watermark so that the sign representing the difference between the summation of said multiplexed audio data corresponding to the first-half cycle of the data for generating a watermark and the summation of said multiplexed audio data corresponding to the later-half cycle of the data for generating a watermark represents the watermark data acquired by the Step S2202 (Step S2003).

Fourth, a multiplexed audio data generation unit generates multiplexed audio data by multiplexing the audio data acquired by Step S2201 and the data for generating a watermark generated by Step S2203 (Step S2204).

According to the sixth embodiment of the present invention, the sign representing the difference between the summation of said multiplexed audio data corresponding to the first-half cycle of the data for generating a watermark and the summation of said multiplexed audio data corresponding to the later-half cycle of the data for generating a watermark represents 0 or 1 of each bit of watermark data, thereby enabling a robust digital watermark without interference of DC offset.

### The Seventh Embodiment

The seventh embodiment of the present invention relates to an audio digital watermark decoding apparatus for decoding watermark data recorded on an audio recording medium, which comprises:
a multiplexed audio data acquisition unit, which acquires multiplexed audio data,
a summation computation unit, which computes the result of a predetermined summation of multiplexed audio data per said predetermined cycle, wherein said multiplexed audio data is acquired by the multiplexed audio data acquisition unit, and
a watermark data decoding unit, which decodes said watermark data based on said result of a predetermined summation computed by said summation computation unit.

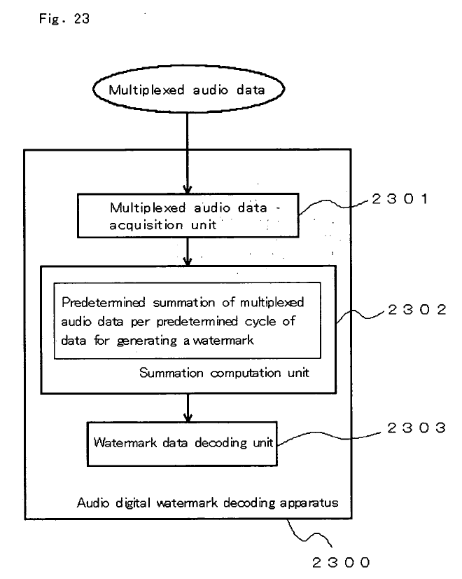

As shown in FIG. 23, the audio digital watermark decoding apparatus 2300 of the seventh embodiment of the present invention comprises a multiplexed audio data acquisition unit 2301, a summation computation unit 2302, and a watermark data decoding unit 2303.

(Multiplexed Audio Data Acquisition Unit)

The multiplexed audio data acquisition unit acquires multiplexed audio data.

(Summation Computation Unit)

The summation computation unit computes a result of predetermined summation per predetermined cycle of multiplexed audio data acquired by the multiplexed audio data acquisition unit.

Here, the “result of predetermined summation of multiplexed audio data per predetermined cycle” corresponds to the result of predetermined summation of data for generating a watermark of multiplexed audio data per predetermined cycle. The “predetermined cycle” corresponds to a half-cycle, 1-cycle, 1.5-cycle, 2-cycle, 2.5-cycle, 3-cycle, and so on. The “predetermined summation” corresponds to the summation of a half-cycle and the summation of one cycle, etc. The “result of predetermined summation” corresponds to the summation per half-cycle, of one cycle, a sign for summation, and a sign representing difference between summations, etc.

(Watermark Data Decoding Unit)

The watermark data decoding unit decodes the watermark data based on the result of a predetermined summation computed by said summation computation unit.

Hereinafter, the seventh embodiment of the present invention will be described by using concrete examples.

(Acquisition of Multiplexed Audio Data)

In the acquisition of multiplexed audio data in the seventh embodiment of the present invention, for example, the multiplexed audio data generated in the first embodiment w(t) is acquired: w(t)=v(t)+{(−1)^{b}·S−Vᵢ}·u(t)/U.

Here, symbols represent the same meaning as that in the first embodiment of the present invention.

(Computation of Summation)

As described in the first embodiment of the present invention, the summation of the multiplexed audio data per 1 cycle of the i-th cycle is:

$$\begin{matrix}\sum w ( t ) = {( - 1 )}^{b} \cdot S \\ = + S ( b = 0 ) \\ = - S ( b = 1 )\end{matrix}$$

(Decoding Watermark Data)

As the above formula, the difference of each bit-value is represented by the difference of the sign of the summation of the multiplexed audio data, so that it becomes possible to derive the summation of one cycle, to judge 0 or 1 of each bit of watermark data, and to decode.

(Detection Process of a Watermark)

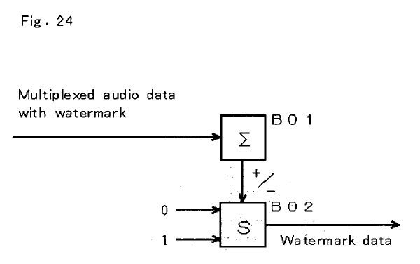

FIG. 24 is a block diagram illustrating the detection process of watermark data. In FIG. 24, each sample value of the multiplexed audio data with a watermark per one cycle of the data for generating a watermark is inputted to B01; the summation per 1 cycle is computed; and the sign thereof is outputted to B02. In B02, 0 or 1 is selected according to the sign, and is outputted as watermark data.

(Other Features)

The other features are the same as the other features in the first embodiment of the present invention, so that the description thereof is omitted.

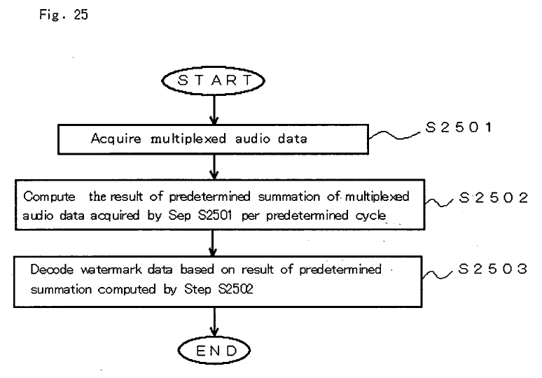

In FIG. 25, the process of the seventh embodiment is illustrated.

First, a multiplexed audio data acquisition unit acquires multiplexed audio data in which data for generating a watermark and audio data are multiplexed (Step S2501).

Second, a summation computation unit computes the result of a predetermined summation of multiplexed audio data per predetermined cycle, wherein the multiplexed audio data is acquired by Step S2501 (Step S2502).

Third, a watermark data decoding unit decodes the watermark data based on the result of a predetermined summation computed by Step S2502 (Step S2503).

According to the seventh embodiment of the present invention, it becomes possible to judge 0 or 1 of each bit of watermark data by the result of a predetermined summation of multiplexed audio data per predetermined cycle of data for generating a watermark, thereby enabling easy detection/decoding of watermark data. Moreover, said result of a predetermined summation is resistant to modification of audio data, thereby implementing a robust digital watermark.

### The Eighth Embodiment

The eighth embodiment of the present invention relates to the audio digital watermark decoding apparatus according to claim 7, which decodes watermark data based on the sign for the summation of the multiplexed audio data over a period of half-cycle of the data for generating a watermark.

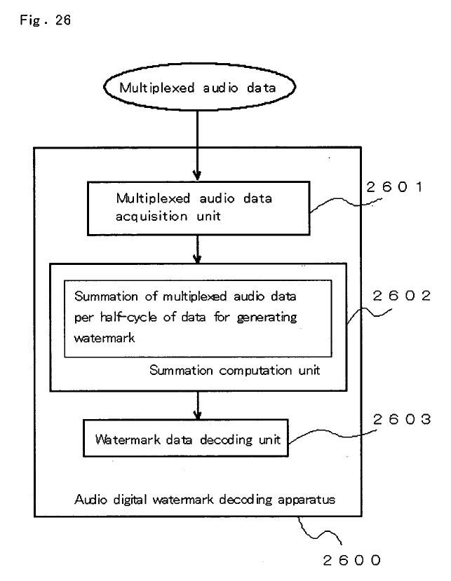

As shown in FIG. 26, the audio digital watermark decoding apparatus 2600 of the eighth embodiment of the present invention comprises a multiplexed audio data acquisition unit 2601, a summation computation unit 2602, and a watermark data decoding unit 2603.

(Multiplexed Audio Data Acquisition Unit)

The multiplexed audio data acquisition unit acquires multiplexed audio data.

(Summation Computation Unit)

The summation computation unit computes the sign of the summation over half-cycle of the data for generating a watermark.

(Watermark Data Decoding Unit)

The watermark data decoding unit decodes the watermark data based on the sign for the summation computed by said summation computation unit.

Hereinafter, the eighth embodiment of the present invention will be described by using concrete examples.

(Acquisition of Multiplexed Audio Data)

In the acquisition of multiplexed audio data in the eighth embodiment of the present invention, for example, the multiplexed audio data generated in the fifth embodiment w(t) is acquired, for the first-half cycle of the i-th cycle, as follows:
w(t)=v(t)+{{(−1)^{b}·S−V₁ᵢ}/U₁}·u(t), and for
the latter-half cycle of the i-th cycle:
w(t)=v(t)+{{−(−1)^{b}·S−V₂ᵢ}/U₂}·u(t)
Here, the symbols represent the same meaning as those in the fifth embodiment of the present invention.

(Computation of Summation)

As described in the fifth embodiment of the present invention, the summation for the multiplexed audio data per first-half cycle and last-half cycle of the i-th cycle are, for the first-half cycle of the i-th cycle, as follows:
Σw(t)=V₁ᵢ+a₁ᵢ·U₁,
=+S (b=0),
=−S (b=1), and for
the latter-half cycle of the i-th cycle:

$$\begin{matrix}\sum w ( t ) = {V}_{2 i} + {a}_{2 i} \cdot {U}_{2} \\ = - S ( b = 0 ) \\ = + S ( b = 1 )\end{matrix}$$

(Decoding Watermark Data)

As the above formula, the difference of each bit-value is represented by the difference of the sign for the summation of the multiplexed audio data, so that it becomes possible to derive the summation per first-half cycle or per latter-half cycle, to judge 0 or 1 of each bit of watermark data, and to decode.

(Detection Process of a Watermark)

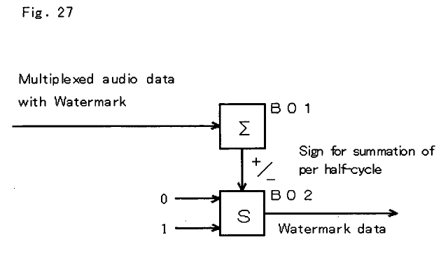

FIG. 27 is a block diagram illustrating the detection process of watermark data. In FIG. 27, each sample value of the multiplexed audio data with a watermark per half-cycle (per first-half cycle or per latter-half cycle) of the data for generating a watermark is inputted to B01, the summation per half-cycle is computed, and the sign thereof is outputted to B02. In B02, 0 or 1 is selected according to the sign, and is outputted as watermark data.

(Other Features)

The other features are the same as the other features in the first embodiment of the present invention, so that the description thereof is omitted.

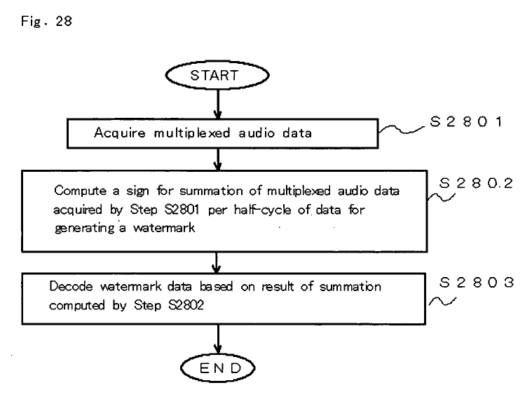

In FIG. 28, the process of the eighth embodiment is illustrated.

First, a multiplexed audio data acquisition unit acquires multiplexed audio data in which data for generating a watermark and audio data are multiplexed (Step S2801).

Second, a summation computation unit computes the result of a predetermined summation of multiplexed audio data per predetermined cycle, wherein the multiplexed audio data is acquired by Step S2801 (Step S2802).

Third, a watermark data decoding unit judges the bit-value from the sign of a summation computed by Step S2802 and decodes it (Step S2803).

According to the eighth embodiment of the present invention, it becomes possible to judge 0 or 1 of each bit of watermark data by the sign for the summation of the multiplexed audio data over a period of a half-cycle of the data for generating a watermark, thereby enabling easy detection/decoding of watermark data. Moreover, the absolute value of said predetermined summation is always a fixed value different from zero, thereby implementing a robust digital watermark resistant to modification of audio data.

### The Ninth Embodiment

The ninth embodiment of the present invention relates to the audio digital watermark decoding apparatus according to claim 7, which decodes watermark data based on the sign of the difference between the summation of said multiplexed audio data over a period of a half-cycle, the first-half of one cycle, and the summation of said multiplexed audio data over a period of a half-cycle, the latter-half thereof.

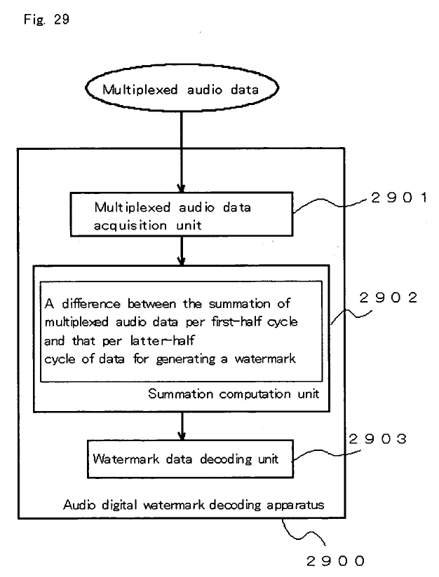

As shown in FIG. 29, the audio digital watermark decoding apparatus 2900 of the ninth embodiment of the present invention comprises a multiplexed audio data acquisition unit 2901, a summation computation unit 2902, and a watermark data decoding unit 2903.

(Multiplexed Audio Data Acquisition Unit)

The multiplexed audio data acquisition unit acquires multiplexed audio data.

(Summation Computation Unit)

The summation computation unit computes the sign of a difference between the summation of said multiplexed audio data over a period of a half-cycle, the first-half of one cycle, and a summation of said multiplexed audio data over a period of a half-cycle, the later-half thereof.

(Watermark Data Decoding Unit)

The watermark data decoding unit decodes the watermark data based on the sign representing the difference of the summation computed by said summation computation unit.

Hereinafter, the ninth embodiment of the present invention will be described by using concrete examples.

(Acquisition of Multiplexed Audio Data)

In the acquisition of multiplexed audio data in the ninth embodiment of the present invention, for example, the multiplexed audio data generated in the sixth embodiment, w(t), is acquired as follows for the first-half cycle of the i-th cycle:
w(t)=v(t)+{{(−1)^{b}·S−V₁ᵢ}/U₁}·u(t), and for
the latter-half cycle of the i-th cycle:
w(t)=v(t)+{{−(−1)^{b} S−V₂ᵢ}/U₂}·u(t).
Here, the symbols represent the same meaning as those in the sixth embodiment of the present invention.

(Computation of Summation)

As described in the sixth embodiment of the present invention, the summation of the multiplexed audio data per the first-half cycle and the latter-half cycle of the i-th cycle are for the first-half-cycle of the i-th cycle:
Σw(t)=+S(b=0)=
−S(b=1), and for
the latter-half cycle of the i-th cycle:

$$\begin{matrix}\sum w ( t ) = - S ( b = 0 ) \\ = + S ( b = 1 )\end{matrix}$$

(Decoding Watermark Data)

As the above formula, the difference of each bit-value is represented by the difference of the sign of the above formula.

In deriving the summation per the latter-half cycle from the summation of the first-half cycle, there are as follows:
+2S(b=0)
−2S(b=1)
Here, by the above sign, it becomes possible to judge the bit-value; thus, DC offset can be cancelled. In the ninth embodiment of the present invention, it is implemented to eliminate the interference of DC offset.

(Detection Process of a Watermark)

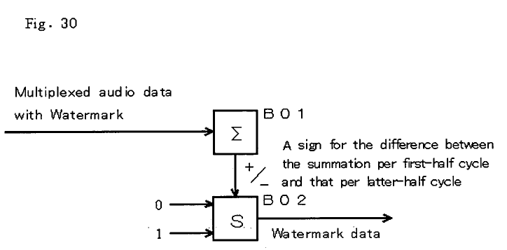

FIG. 30 is a block diagram illustrating the detection process of watermark data. In FIG. 27, the multiplexed audio data with watermark data per half-cycle of the data for generating a watermark is inputted to B01, the difference between the summation per half-cycle and that per latter-half cycle is computed, and the sign thereof is outputted to B02. In B02, 0 or 1 is selected according to the sign, and is outputted as watermark data.

(Other Features)

The other features are the same as the other features in the first embodiment of the present invention, so that the description thereof is omitted.

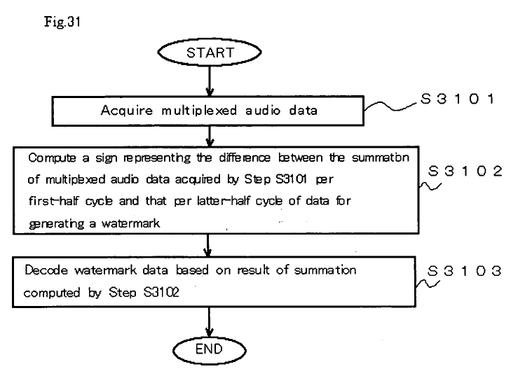

In FIG. 31, the process of the ninth embodiment is illustrated.

First, a multiplexed audio data acquisition unit acquires multiplexed audio data in which data for generating a watermark and audio data are multiplexed (Step S3101). Second, a summation computation unit computes the sign of the difference between the summation of said multiplexed audio data over a period of a half-cycle, the first-half of one cycle, and the summation of said multiplexed audio data over a period of a half-cycle, the latter-half thereof, wherein the multiplexed audio data is acquired by Step S3101 (Step S3102).

Third, a watermark data decoding unit decodes the watermark data so that the sign of the value computed by Step S3102 represents the bit-value of the watermark data (Step S3103).

According to the ninth embodiment of the present invention, 0 or 1 of each bit of watermark data is judged from the sign of the difference between the summation of said multiplexed audio data over a period of a half-cycle, the first-half of one cycle, and the summation of said multiplexed audio data over a period of a half-cycle, the latter-half thereof, so that DC offset is cancelled. Therefore, it becomes possible to implement a digital watermark which is resistant to distortion.

### INDUSTRIAL APPLICABILITY

According to the present invention, since the data of inaudible low frequency is used as data for generating a watermark, even if amplitude of data for generating a watermark is wide, it becomes possible to implement a robust digital watermark without the degradation of sound quality of the original audio data.

Moreover, since one bit is encoded at one wavelength of data for generating a watermark, if the data for generating a watermark has a long wavelength, it becomes possible to embed a large amount of watermark data effectively.

Moreover, not the data for generating a watermark, but the sign of the result of a predetermined summation per predetermined cycle of multiplexed audio data, in which the data for generating a watermark and the original audio data are multiplexed, corresponds to the bit-value of watermark data, thereby enabling easy detection/decoding.

Moreover, the above process of embedding a watermark is reversible, so that it is possible to perfectly recover if there is time-series data of amplitude of the data for generating watermark which has been used in embedding the watermark data. Moreover, even if after watermark data has been embedded, the other watermark data is embedded by another person; it is possible to extract each watermark data and recover the original audio data. Thus, the present invention enables to embedding of a watermark several times over. Therefore, for example, it becomes possible to embed a unique ID for a content provider for the purpose of preventing fraudulent secondary distribution while protecting copyright thereof after a copyright holder embeds information on the copyright.

Moreover, it is impossible to recover the original state of the data without the time-series data of amplitude of the data for generating watermark which has been used in embedding the watermark data, so that no one other than the person who owns said time-series data of first embedding of the watermark data can recover the original audio data. Therefore, by using the above aspect of the present invention, it is possible to establish a digital watermark system, which is highly resistant to falsification.

1. An audio digital watermark apparatus for recording watermark data on a voice-recording medium, which comprises:
an audio data acquisition unit, which acquires audio data;
a watermark data acquisition unit, which acquires watermark data;
a data generation unit for generating data for a watermark, which generates data for generating a watermark by multiplexing the audio data acquired by said audio data acquisition unit and the data for generating a watermark generated by said data generation unit for generating data for a watermark, wherein the result of a predetermined summation of multiplexed audio data per predetermined cycle represents the watermark data acquired by said watermark data acquisition unit; and
a multiplexed audio data generation unit, which generates multiplexed audio data by multiplexing the audio data acquired by said audio data acquisition unit and the data for generating a watermark generated by said data generation unit for generating data for a watermark.

2. The audio digital watermark apparatus according to claim 1, wherein said data generation unit for generating data for a watermark generates the data for a watermark of inaudible low frequency.

3. The audio digital watermark apparatus according to claim 1, wherein said data generation unit for generating data for a watermark generates the data for a watermark, in which the value and the slope of the boundary for changing the amplitude of a function of the data for generating a watermark, which is generated by the data generation unit for generating data for a watermark, are always zero.

4. The audio digital watermark apparatus according to claim 1, wherein said data generation unit for generating data for a watermark correspondingly changes the amplitude of a function represented by said data for generating a watermark per half-cycle so that said result of the predetermined summation per said predetermined cycle represents the watermark data acquired by said watermark data acquisition unit.

5. The audio digital watermark apparatus according to claim 1, wherein said result of the predetermined summation per said predetermined cycle is a sign of summation of said multiplexed audio data per half-cycle of said data for generating a watermark.

6. The audio digital watermark apparatus according to claim 1, wherein said result of the predetermined summation per said predetermined cycle is a sign representing the difference between the summation of said multiplexed audio data corresponding to the first-half cycle of the data for generating a watermark and the summation of said multiplexed audio data corresponding to the latter-half cycle of the data for generating a watermark.

7. An audio digital watermark decoding apparatus for decoding a watermark data recorded on an audio recording medium, which comprises:
a multiplexed audio data acquisition unit, which acquires multiplexed audio data,
a summation computation unit, which computes the result of a predetermined summation of multiplexed audio data per said predetermined cycle, wherein said multiplexed audio data is acquired by the multiplexed audio data acquisition unit, and
a watermark data decoding unit, which decodes said watermark data based on said result of a predetermined summation computed by said summation computation unit.

8. The audio digital watermark decoding apparatus according to claim 7, wherein said summation computation unit computes a sign of a summation of said multiplexed audio data over a period of a half-cycle of said data for generating a watermark, in which said multiplexed audio data is acquired by the multiplexed audio data acquisition unit.

9. The audio digital watermark decoding apparatus according to claim 7, wherein said summation computation unit computes a sign of the difference between a summation of said multiplexed audio data over a period of a half-cycle, the first half of one cycle, and a summation of said multiplexed audio data over a period of a half-cycle, the latter half thereof, in which said multiplexed audio data is acquired by said multiplexed audio data acquisition unit.

10. An audio digital watermark recording method for recording watermark data on a voice recording medium, which comprises:
an audio data acquisition step of acquiring audio data;
a watermark data acquisition step of acquiring watermark data;
a data generation step for generating data for a watermark, which generates data for a watermark by multiplexing the audio data acquired by said audio data acquisition step and the data for generating a watermark generated by said data generation step for generating data for a watermark, wherein a result of a predetermined summation of multiplexed audio data per predetermined cycle represents the watermark data acquired by said watermark data acquisition step; and
a multiplexed audio data generation step, which generates multiplexed audio data by multiplexing the audio data acquired by said audio data acquisition step and the data for generating a watermark generated by said data generation step for generating data for a watermark.

11. The audio digital watermark recording method according to claim 10, wherein said data generation step for generating data for a watermark generates the data for a watermark of inaudible low frequency.

12. The audio digital watermark recording method according to claim 10, wherein said data generation step for generating data for a watermark generates the data for a watermark, in which the value and the slope of the boundary for changing the amplitude of a function of the data for generating a watermark, which is generated by the data generation step for generating data for a watermark, are always zero.

13. The audio digital watermark recording method according to claim 10, wherein said data generation step for generating data for a watermark correspondingly changes the amplitude of a function represented by said data for generating a watermark per half-cycle so that said result of the predetermined summation per said predetermined cycle represents the watermark data acquired by said watermark data acquisition step.

14. The audio digital watermark recording method according to claim 10, wherein said result of the predetermined summation per said predetermined cycle is a sign of summation of said multiplexed audio data per half-cycle of said data for generating a watermark.

15. The audio digital watermark recording method according to claim 10, wherein said result of the predetermined summation per said predetermined cycle is a sign representing the difference between the summation of said multiplexed audio data corresponding to the first-half cycle of the data for generating a watermark and the summation of said multiplexed audio data corresponding to the latter-half cycle of the data for generating a watermark.

16. An audio digital watermark decoding method for decoding a watermark data recorded on an audio recording medium, which comprises:
a multiplexed audio data acquisition step of acquiring multiplexed audio data,
a summation computation step of computing the result of a predetermined summation of multiplexed audio data per said predetermined cycle, wherein said multiplexed audio data is acquired by the multiplexed audio data acquisition step, and
a watermark data decoding step of decoding said watermark data based on said result of a predetermined summation computed by said summation computation step.

17. The audio digital watermark decoding method according to claim 16, wherein said summation computation step computes a sign of a summation of said multiplexed audio data over a period of half-cycle of said data for generating a watermark, in which said multiplexed audio data is acquired by the multiplexed audio data acquisition step.

18. The audio digital watermark decoding method according to claim 16, wherein said summation computation step computes a sign of the difference between a summation of said multiplexed audio data over a period of a half-cycle, the first half of one cycle, and a summation of said multiplexed audio data over a period of a half-cycle, the latter half thereof, in which said multiplexed audio data is acquired by said multiplexed audio data acquisition step.
